(19) United States
(12) Patent Application Publication
(10) Pub. No.: US 2016/0379188 A1
(43) Pub. Date: Dec. 29, 2016

(54) METHODS AND APPARATUS FOR FINANCIAL TRANSACTIONS

(71) Applicant: ARA Technology, LLC, Newport Beach, CA (US)

(72) Inventors: BRAD BARTON, Newport Beach, CA (US); Eric Choi, Newport Beach, CA (US)

(21) Appl. No.: 14/751,067

(22) Filed: Jun. 25, 2015

(51) Int. Cl. G06Q 20/10; G06K 9/62; G06Q 30/02

(52) U.S. Cl. CPC G06Q 20/10; G06Q 30/0279; G06K 9/6201

(57) ABSTRACT

Methods and apparatus for transferring funds are disclosed. In particular methods and systems for transferring funds comprising: receiving an image of a logo from a mobile device wherein the image of a logo has been captured by an image capture device integrated into the mobile device; receiving data from the mobile device, the data associated with the image of a logo and identifying a sending party's account; comparing the image of a logo with a plurality of images of logos stored in a database; finding a matching image from the plurality of images of logos; determining a receiving party's account associated with the matching image; and, causing funds to be transferred from the sending party's account to the receiving party's account.

The present patent document relates to financial transactions. More particularly, the present patent document relates to identifying a source for funds to be sent in a financial transaction by image matching.

### BACKGROUND

Billions of financial transactions occur every day. In these transactions, money is sent from a buyer to a seller. In many transactions, there are also one or more entities that act as middle men to facilitate the transaction. For example, credit card companies, banks, online companies such as Paypal®, mobile wallets, Square®, Apple pay and numerous other entities may all be involved in facilitating the transaction.

A typical credit card transaction happens in a multistage process. In a typical transaction, a customer completes a transaction at the merchant point of sale. The point of sale system passes the transaction, card, and merchant bank information to a Payment Gateway. The Payment Gateway collects the information and passes it securely to the Payment Processor. The Payment Processor identifies the correct Network/Association based on the card type and routes the transaction data to the Network for approval.

The Network verifies the available balance with the Card Issuer and often does a security check to make sure the transaction is within normal spending patterns. If the transaction is approved by the Card Issuer and passes the security check, the Network passes an affirmative response back to the point of sale and also to the Card Issuer. At this point the transaction is approved and the sale occurs. However, typically at this point, no money actually changes hands. At some time in the future, settlement occurs and the Merchant passes a pool of authorization to the Network and the money is eventually pulled from a customer account and placed into the Merchant account.

There are two main types of banks in transactions that include credit, the first is the issuing bank. The issuing bank is a bank that offers credit and credit cards directly to consumers. The issuing bank assumes the primary liability for the consumer's capacity to pay off debts they incur with their card. As is well known, when a consumer acquires a credit card from an issuing bank, the terms of the credit and the penalties for not timely paying off the debt are established.

The second main type of bank is an acquiring bank, which is sometimes referred to as a merchant bank. The acquiring bank provides the merchant with a merchant account and the ability to accept credit cards by providing them with the equipment to do so. The acquiring bank exchanges funds with the issuing banks on behalf of the merchant and pays the merchant for its daily activities minus fees. The fees are collected by the acquiring bank in exchange for providing the ability to accept credit card payments to the merchant.

The current system has been in place for many years and provides millions of people with the ability to buy products in a convenient manner. However, in order to do so, the consumer typically needs to be at a point of sale. The consumer needs to not only be at a point of sale but also needs to be at a point of sale with the necessary equipment and network and data connections to process the transaction. In today's mobile world, consumers may want to enter into financial transactions when they are not conveniently located at a point of sale. This may be particularly true for charities who are continuously looking to receive money from people located in many different places none of which are usually ever at a point of sale.

To this end, methods and systems to more effectively allow financial transaction to occur would be beneficial. Moreover, methods and systems that allow financial transactions to occur when consumers are not at a point of sale would be beneficial.

### SUMMARY OF THE EMBODIMENTS

In view of the foregoing, an object according to one aspect of the present patent document is to provide methods and apparatus for financial transactions. Preferably, the methods and apparatuses address, or at least ameliorate, one or more of the problems described above. To this end, a method of transferring funds is provided. In one embodiment, the method of transferring funds comprises: receiving an image of a logo from a mobile device wherein the image of a logo has been captured by an image capture device integrated into the mobile device; receiving data from the mobile device, wherein the data is associated with the image of a logo and identifies a sending party's account; comparing the image of a logo with a plurality of images of logos stored in a database; finding a matching image from the plurality of images of logos; determining a receiving party's account associated with the matching image; and, causing funds to be transferred from the sending party's account to the receiving party's account.

In some embodiments, the image of a logo is a trademark or other type of image that identifies the origin of the goods or services.

The receiving party's account may be owned by anyone or any entity. In some embodiments, the receiving party's account is owned by a charity and the methods and apparatus disclosed herein are used to make donations to charities.

In some embodiments, a processing fee may be charged. Preferably, the processing fee or transaction fee is charged to the receiving party's account, which in some embodiments may be a merchant. However, in other embodiments, other entities or individuals may contribute to the payment of the processing fees. In embodiments that include processing fees, at least a portion of the processing fee may be donated to a charity. In some such embodiments, the party receiving the funds may select the charity while in other embodiments, the charity may be selected by the party sending the funds.

In addition to transferring data about the sending account, the data transferred to the network may also include an amount to be transferred. In other embodiments, the amount to be transferred may be identified by the server once a match of the image has been completed.

In various different embodiments, the sending party's account and the receiving party's account may be in many different forms. The accounts may simply be bank accounts or credit cards and may involve credit card processing or other types of process such as automated clearing house (“ACH”) processing. In some embodiments, the consumer account is a mobile wallet attached to a plurality of funding sources.

The amount transferred between the sending party and the receiving party may be any amount. In some embodiments, the amount may be related to goods or services received by the sender. In other embodiments, the amount transferred may be a donation to a charity.

Further aspects, objects, desirable features, and advantages of the apparatus and methods disclosed herein will be better understood from the detailed description and drawings that follow in which various embodiments are illustrated by way of example. It is to be expressly understood, however, that the drawings are for the purpose of illustration only and are not intended as a definition of the limits of the claimed embodiments.

### BRIEF DESCRIPTION OF THE DRAWINGS

FIG. 1 illustrates an item with a logo, a database with a plurality of logo images, and a mobile device.

FIG. 2 illustrates one embodiment of a home screen of a mobile application for facilitating a financial transfer according to the methods taught herein.

FIG. 3 illustrates one embodiment of a Wallet Screen for a mobile application according to the embodiments described herein.

FIG. 4 illustrates one embodiment of an Activity Screen for a mobile application according to the embodiments described herein.

FIG. 5 illustrates one embodiment of a Profile Screen for a mobile application according to the embodiments described herein.

FIG. 6 illustrates one embodiment of a Find a Merchant Screen for a mobile application according to the embodiments described herein.

FIG. 7 illustrates one embodiment of a Scan to Pay Screen for a mobile application according to the embodiments described herein.

### DETAILED DESCRIPTION OF THE EMBODIMENTS

In the following description, for purposes of explanation only, specific nomenclature is set forth to provide a thorough understanding of the various embodiments described herein. However, it will be apparent to one skilled in the art that these specific details are not required to practice the concepts described.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Also disclosed is an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk, including floppy disks, optical disks, CD-ROMs, and magnetic-optical disks, read-only memories (ROMs), random access memories (RAMs), erasable programmable read-only memories (EPROMs), electrically erasable programmable read-only memories (EEPROMs), magnetic or optical cards, non-volatile memory, or any type of media suitable for storing electronic instructions, and each coupled to a computer system bus.

The algorithms presented herein are not inherently related to any particular computer or other apparatus. The required structure for a variety of these systems will appear from the description below. It will be appreciated that a variety of programming languages may be used to implement the present teachings.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

As used herein, the phrase “sending party” or “sender” or “consumer” means any person or entity transferring funds to an entity or individual. A sender may in fact receive some type of goods and/or services for the funds transferred, but no goods and services are required to be exchanged. For example, a sender may make a donation to a charity. In the present application, the term “consumer” may be used in place of “sending party” or “sender.”

As used herein, the phrase “receiving party” or “receiver” or “merchant” means any person or entity that receives funds from a sender. As used herein, a “receiver” includes charities, friends, family members, acquaintances or any persons or entities that receive funds from a consumer. In the present application, the term “merchant” may be used in place of “receiving party” or “receiver.”

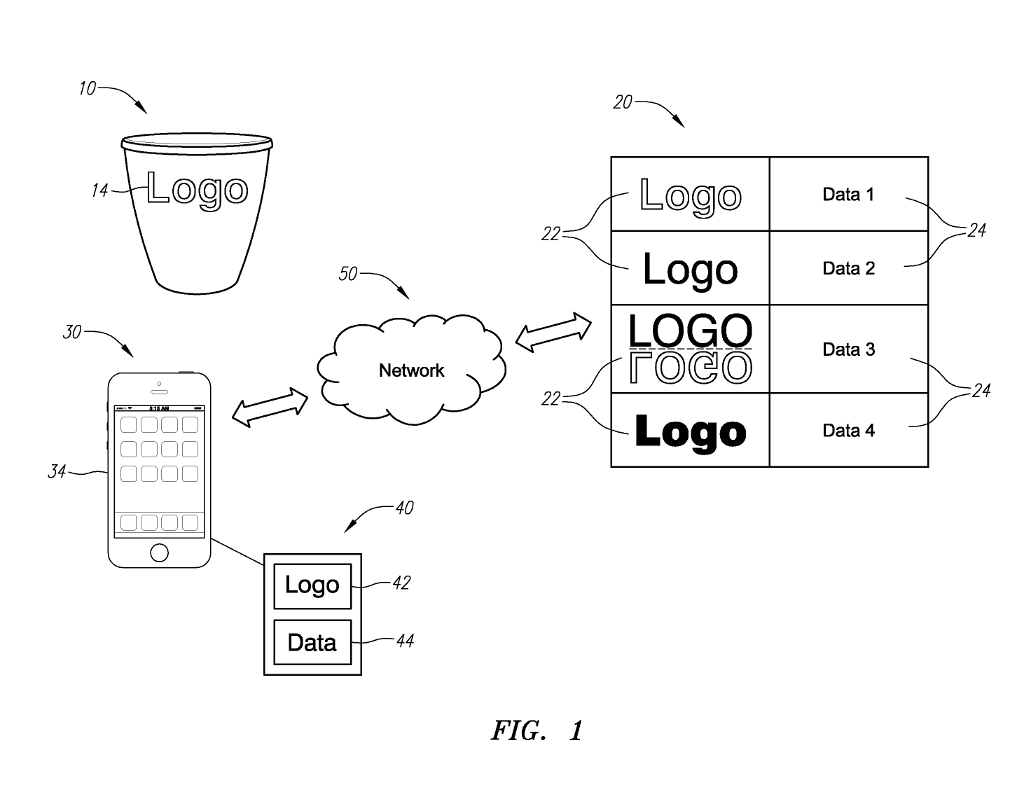

FIG. 1 illustrates an item 10 with an identifying image 14, a database with a plurality of identifying images 22, and a mobile device 30. In a preferred embodiment, a consumer uses a mobile device 30 including an image capture device 34 and captures an identifying image 14 from an item 10. In a preferred embodiment, the captured image 42 is then transferred to a network 50 along with additional transaction information 44. The network 50 routes the information 40 to a server 20 where the captured image 42 is compared to a database of stored images 22. When a match is confirmed, the dataset 24 associated with the stored image 22 is returned. The dataset 24 includes information needed for the transaction including the account associated with the stored image 22 that matched the captured image 42. The financial transaction may then be completed with the associated account.

In a preferred embodiment, the identifying image 14 is a logo or trademark. As used herein “logo” refers to a picture or image that is not a barcode or some other type of image which means nothing to a consumer but rather is a picture that allows the consumer to know the source associated with the image by simply seeing the logo. In other embodiments, the identifying image 14 may be any type of image capable of capture. For example, identifying image 14 may be a barcode, quick response (“QR”) code, or any other type of identifying image 14.

The mobile device 30 used by a sending party may be any type of mobile device 30 with an image capture device 34. In a preferred embodiment, the mobile device 30 is a smartphone. However, in other embodiments, the mobile device 30 may be a handheld computer, a personal digital assistant, a cellular telephone, a network appliance, a camera, a smart phone, an enhanced general packet radio service (EGPRS) mobile phone, a network base station, a media player, a navigation device, an email device, a game console, a tablet, a watch, a laptop computer or a combination of any two or more of these data processing devices or other data processing devices.

The image capture device 34 is preferably a camera located on the mobile device 30 and more particularly a camera on a smartphone. However, it may be possible to use other types of sensors to capture image 42 including sensors specifically designed for reading barcodes or other types of sensors. Other sensors may include a charged coupled device (CCD) or a complementary metal-oxide semiconductor (CMOS) optical sensor. Generally, any type of sensor that can record or capture images or video may be used.

In preferred embodiments, the captured image 42 is transferred from the mobile device 30 to a network 50. Network 50 may be any type of network including any type of telecommunications network, Internet, intranet, telephone network, virtual private network, local area network or any other type of network. The network 50 may use numerous different types of technologies to transfer the data including IEEE 802.x communication protocols (e.g., WiMax, Wi-Fi), code division multiple access (CDMA), global system for mobile communications (GSM), and Enhanced Data GSM Environment (EDGE), third generation (3G), 3GPP Long Term Evolution (LTE), and LTE Advanced.

In addition to the captured image 42, the mobile device 30 may also send transactional data 44 to the network 50. The transactional data 44 may be any type of data. In preferred embodiments, the transactional data 44 includes information able to identify the sending party or sending party's account and information about the amount of the transaction. In yet other embodiments, other data subsets may be part of the submission 40 to the network 50 including: security data, time and date stamps, error correction and other financial transaction data, to name a few examples.

The network 50 routes the submission 40 to a server 20. The server 20 either includes, or is in communication with, a database with a plurality of stored images 22. Each of the stored images 22 is associated with a dataset 24. The dataset 24 associated with each stored image 22 includes information about a financial account associated with each of the stored images 22.

An image recognition analysis is preformed between the captured image 42 sent by the mobile device 30 and the stored images 22. The image recognition may take into consideration color, fonts, shape, text or various other aspects of the images. If a match between the captured image 42 and the stored images 22 is found, the dataset 24 associated with the matched image is returned. The dataset 24 includes information about a financial account associated with the matched image. In a preferred embodiment the dataset 24 may also include other information like the owner of the account, account numbers, details about the image or other information associating the stored image 22 with a person or entity and/or their accounts.

In operation, a sending party desirous of sending money—to complete a purchase or for some other reason—to a receiving party can scan the receiving party's trademark or logo from a newspaper, hat, cup or even website and enter an amount to send to the merchant. The system will match the scanned logo against a database of stored logos for each of the receiving parties that have accounts in the system. Assuming the receiving party has an account on the system, a match will be found and the receiving party's account information returned. The transaction can then proceed, be authorized, and the money transferred from the sender to the receiver.

The method is advantageous over previous methods of financial transactions because a party trying to send money does not need to be co-located with the receiving party so that the sending party has access to the typical merchant equipment provided by acquiring banks to allow credit card or other types of payments to be accepted by the receiving party. A sender can use his/her mobile device 30 to facilitate the financial transaction. Moreover, the sender does not need to try and figure out who the receiving party is or how to connect to his/her account. All the sending party has to do is to scan in the logo or other image associated with the receiving party the sender wants to send funds to and, complete the transaction. This may be particularly advantageous over existing methods that often require a sender to enter in an email address of a receiving party the sending party wants to send funds to. Given the complexity of many email addresses, it is very easy to incorrectly enter such an address and potentially send funds to the wrong person or entity. Email addresses are also difficult to remember from one screen on the mobile device to another and therefore, may be entered incorrectly. To this end, the methods and apparatus discussed herein have a significant advantage over existing methods and apparatus.

In addition, a logo or trademark may now be used to not only promote the brand, but also as a potential continuous source of income. Any promotional items or other items that are disseminated by a merchant, charity or the like that include a logo may now potentially be used as a source of income. Anyone scanning in the logo from the promotional item may identify and send money to the owner of the logo simply by scanning in the logo. As just one example, a consumer trying to order a pizza may simply scan the logo of the restaurant from the takeout menu or pamphlet left on his/her door and proceed to send money to the restaurant delivering the pizza.

In some embodiments, scanning in the logo may initiate the entire transaction not just facilitate the sending of funds. Using the Pizza example, a consumer may scan in the logo of a restaurant and the system may find a match for that logo and redirect the consumer to an interface that allows the consumer to both select from a list of available items from the restaurant and also calculate a total and submit payment for those items. In such an embodiment, dataset 24 may include additional information associated with the captured image 22 such as URLs, menu information, or links to other databases with additional information about the merchant or the merchant's goods and services associated with the matched captured image 22.

In preferred embodiments, the systems and methods described herein may be particularly useful in association with charities. Charities are typically not providing a product or service in exchange for funds. To this end, a person or entity may want to donate to a charity from any place and at any time. An important factor for charities in their quest to raise funds is convenience. More people will donate if the donation is made convenient enough. The methods and apparatus taught herein make the donation to a charity easier and thus, more likely to occur. Any person at any time may simply scan in the charities logo/trademark, or other image associated with the charity, and make a donation. To this end, promotional items distributed by the charity with their logo may be a source of revenue into perpetuity.

In yet other embodiments, specific philanthropic efforts may be set up by various entities. For example, a natural disaster may occur and particular persons or entities may allow people to scan in their logos/trademarks for a limited time to make a donation to a particular relief effort. As an example, suppose when hurricane Katrina hit, certain merchants allowed people to donate to the Katrina relief fund by scanning in their logo and making a donation for a certain period of time.

In yet other embodiments, specific logos may be created to allow funds to be directed to specific causes/accounts. For example, a single person or entity may have multiple logos and multiple accounts. Depending on the particular logo scanned in, a different account may be associated. In yet other embodiments, multiple accounts may be associated with a single logo and the sending party may be given the option to select from the plurality of accounts after scanning in the logo/trademark.

In a preferred embodiment, a database exists that contains a plurality of entries. Each entry includes an image of a logo 22 and financial account information 24 associated with the logo. A server, which may be the same server as the database or a different server, performs a query of the database and tries to determine a match for a target image received by the server. Once a match is determined, the associated financial information may be extracted from the database. In some embodiments, an interface may be constructed to allow parties desirous of receiving funds to sign up and enter information into the database and create an account such that they can receive funds. In preferred embodiments, an administrative check is performed on requested accounts to ensure they have authority to use the image they are entering into the database.

The actual funds that are being transferred from the sending party to the receiving party may be for any purpose. In some embodiments, the receiving party may be selling goods and services the sending party is purchasing. In such cases, the amount of the transfer may be provided by the database once the image is matched. In other embodiments, the transaction may be a donation to a charity; in which case the amount may be entered by the sending party.

In some embodiments, a transaction fee may be charged. In preferred embodiments, the transaction fee may be automatically charged to the receiving party's account. However, in other embodiments, the sending party may be charged the transaction fee or a portion of the transaction fee. In some embodiments, both the receiving party and the sending party may share the costs of the transaction fee. In such embodiments, the transaction fee may be divided between the sending party and receiving party in any ratio.

In some embodiments, a portion of the transaction fee may be sent to a charity account. The charity information or the charity account that is designated to receive a portion of the transaction fee may be designated by the sending party or the receiving party. The charity accounts may be credited with a portion of the transaction fees automatically as part of the normal settling of the receiving party's accounts.

In some embodiments, both the sending party's and receiving party's accounts are mobile wallets that are connected to funding sources. For example, the sending party and receiving party may have an account with a balance associated with it. The account may also be electronically connected to a checking account, savings account, credit card, other funding source or any combination thereof. Funds may be transferred between the funding source and the mobile wallets as needed.

In preferred embodiments, the transactions may occur entirely within a single third party system. For example, a third party may set up mobile wallets for each account such that a sending party and receiving party may each have a mobile wallet. When the transaction occurs, the third party simply moves funds from the sending parties account to the receiving party's account without the need for any further processing or confirmation. In other embodiments, for example where a credit card is a directly responsible for providing the funds, other parties and other parties' systems may be incorporated in the process.

In yet another embodiment, rather than scanning in a logo or a trademark, a barcode or QR code may be scanned. To this end, the sending party captures an image of the barcode or QR code on his mobile device 30 rather than an image of a logo or trademark. The barcode or QR code may be specifically designed to include data associating the barcode or QR code with a specific receiving party. In some embodiments, the barcode or QR code encodes the receiving parties information in the form of a URL. In such embodiments, the receiving party's information may be extracted on the mobile device 30 or on the server. In embodiments where the receiving party's information is extracted from the bar code or QR code on the server, the captured image of the barcode or QR code may be sent to the server for analysis.

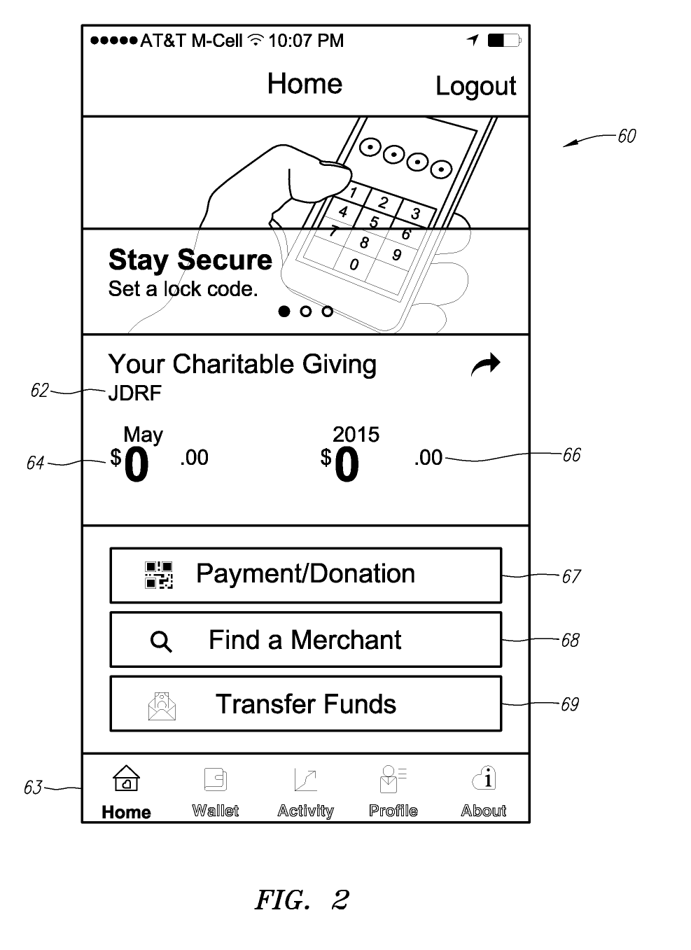

In preferred embodiments, a website or mobile application may be used to facilitate the methods of financial transfer discussed herein. FIG. 2 illustrates one embodiment of a Home Screen 60 of a mobile application for facilitating a financial transfer according to the methods taught herein. In a preferred embodiment, the user has a lock code to login into the mobile application such that the mobile application knows the identity of the user or user's account. To this end, the application and can associate the user's information with this particular instantiation of the application. To this end, the Home Screen 60 may provide a Graphical User Interface (“GUI”) object to allow the user to logout. As is known in the art, a GUI object can have many different forms including buttons, sliders, radio buttons, drop down lists multi-touch controls and numerous other forms. When referring to any particular GUI object, it should be understood that any other type of GUI object may be substituted in its place.

In a preferred embodiment, the Home Screen 60 may have a plurality of buttons 67-69 to facilitate a financial transaction between the sending party and the receiving party. As may be seen in the embodiment shown in FIG. 2, the Home Screen 60 may include a Payment/Donation button 67, a Find a Merchant button 68, and a Transfer Funds button 69. In addition, a plurality of navigation buttons 63 may be provided to allow the user to navigate to different parts of the application. In the embodiment shown in FIG. 2, the navigation buttons 63 include a button for Home, Wallet, Activity, Profile and About. In other embodiments, other navigation buttons may be provided.

In addition to the GUI objects on the Home Screen 60, the Home Screen 60 may display data. In the embodiment shown in FIG. 2, the consumers has selected a specific charity, JDRF, to be the recipient of a portion of all transaction fees associated with the sending party's spending. The name of the charity is displayed on the Home Screen 60 along with the total amount contributed to the charity for the current month 64 and current year 66. In other embodiments, other types of information may be displayed including the user's account balance.

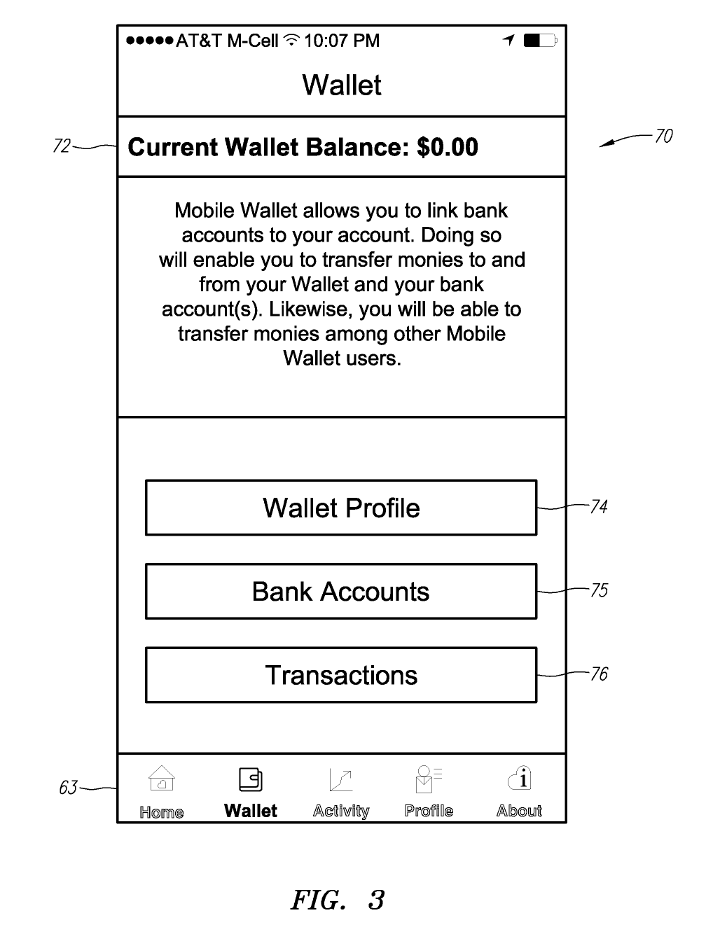

FIG. 3 illustrates one embodiment of a Wallet Screen 70 for a mobile application according to the embodiments described herein. If the user selects the Wallet GUI object from the navigation buttons 63, the user may be navigated to a new Wallet Screen 70 showing the information related to the user's wallet. In the embodiment of a Wallet Screen 70 shown in FIG. 3, the user's current balance 72 is displayed. In addition, the user may be provided with a number of GUI objects 74-76, to manage the user's wallet. For example, a Wallet Profile button 74 may cause to be displayed information associated with the user's wallet. The Bank Accounts button 75 may cause to be displayed information about a user's Bank Accounts that have been associated with the mobile wallet. As previously discussed, the user's bank accounts may be linked to the mobile wallet as sources of funds. Transactions button 76 may display information about pending and completed transactions. Similar to the Home Screen 60, navigation buttons 63 may be displayed across the bottom of the Wallet Screen 70 with the button associated with the current screen highlighted. This may be consistent across all screens.

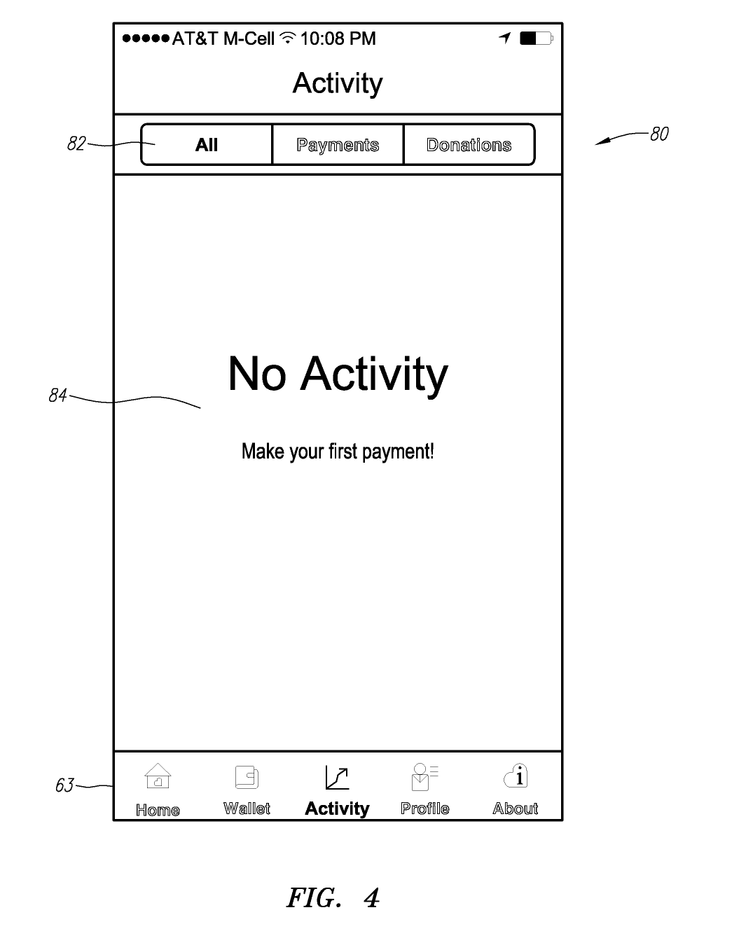

FIG. 4 illustrates one embodiment of an Activity Screen 80 for a mobile application according to the embodiments described herein. If the user selects the Activity GUI object from the navigation buttons 63, the user may be navigated to a new Activity Screen 80 showing the information related to the user's activity. In the embodiment of an Activity Screen 80 shown in FIG. 4, the user's activity 84 may be displayed. As may be seen in FIG. 4, the Activity Screen 80 may include a plurality of buttons 82 to update the display of the user's activity 84. In the embodiment shown in FIG. 4, the buttons 82 include the ability to change between “All” transactions, just “Payments” or, just “Donations.” In other embodiments, other controls may be provided.

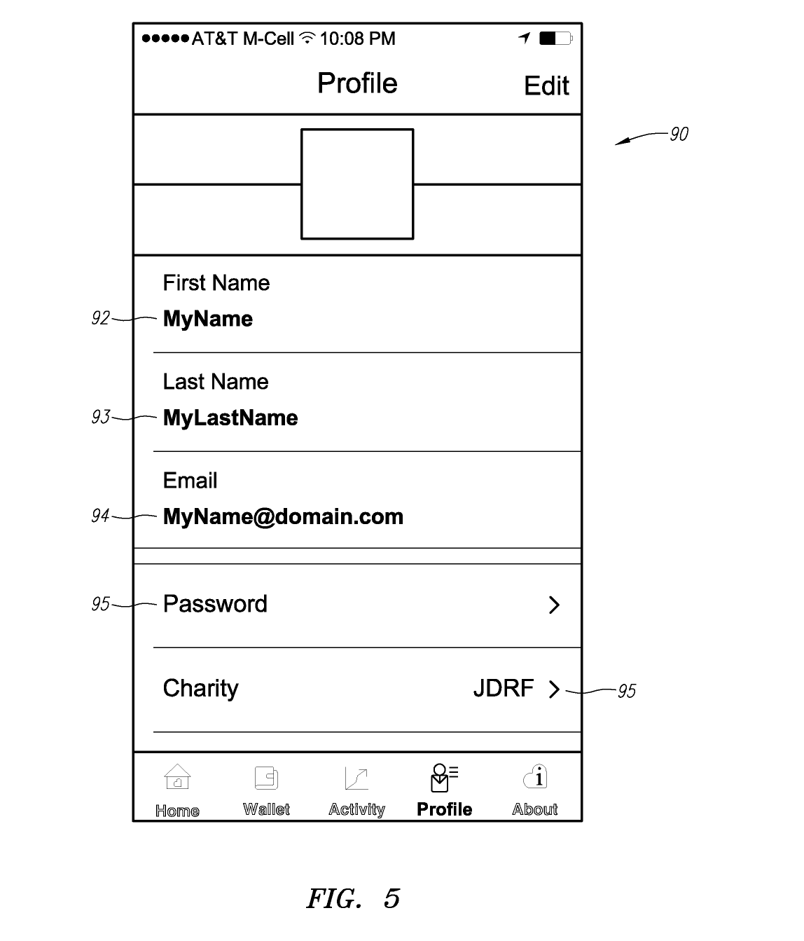

FIG. 5 illustrates one embodiment of a Profile Screen 90 for a mobile application according to the embodiments described herein. If the user selects the Profile GUI object from the navigation buttons 63, the user may be navigated to a new Profile Screen 90 showing the information related to the user's profile. The information displayed on the Profile Screen 90 may be any information related to the user's profile. In the embodiment shown in FIG. 5, the Profile Screen 90 displays the user's First Name 92, Last Name 93, and Email Address 94. In a preferred embodiment, the Profile Screen 90 also displays the charity 95 the user has selected to donate any portion of the transaction fees associated with the user. The Profile Screen 90 may also provide access to the user password 95 and the ability to edit the information associated with the profile of the user.

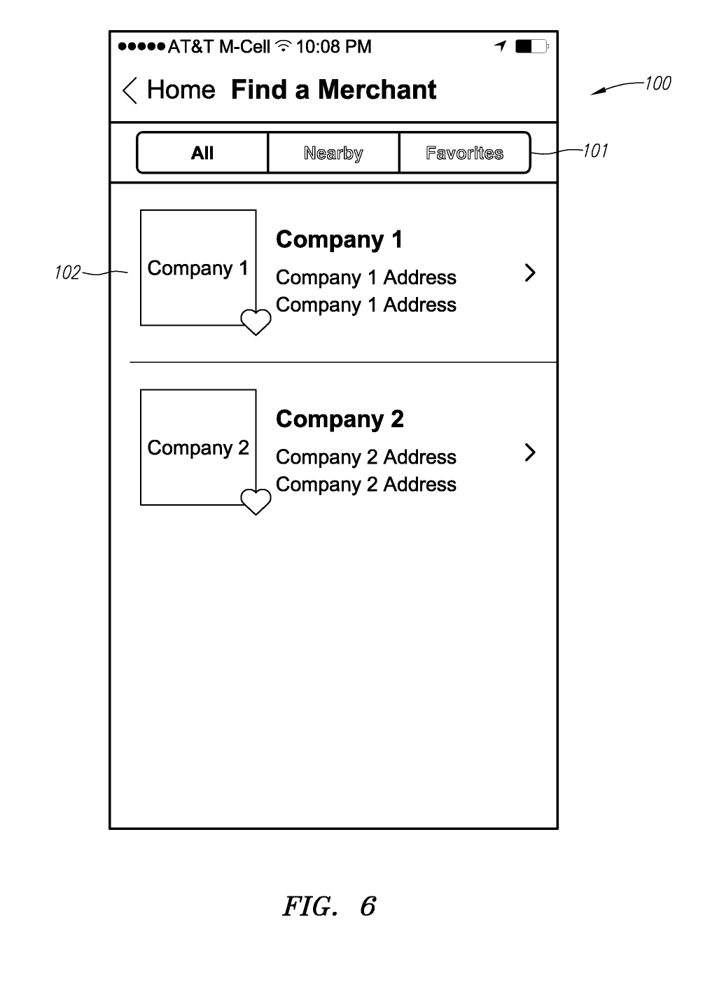

Returning to FIG. 2, the Home Screen 60 may include a GUI object 68 to find a merchant. FIG. 6 illustrates one embodiment of a Find a Merchant Screen 100 for a mobile application according to the embodiments described herein. In some applications, a party desirous of sending money may not have a logo or barcode or QR code or any other image to scan to facilitate a transaction. In such a situation, the sending party may simply search through a list of merchants with merchant accounts on the system using the Find a Merchant screen. Another advantage of the Find a Merchant screen is to allow users to appreciate Merchants that can accept payments using the mobile application. To this end, the Find a Merchant Screen 100 may serve this purpose. In the embodiment shown in FIG. 6, the Find a Merchant Screen 100 includes a scrollable list 102 of merchants that have merchant accounts on the system. The embodiment shown also has a list of GUI objects 101 to allow the user to reconfigure the scrollable list to show either “All” the merchants, “Nearby” merchants, or “Favorite” merchants. The “Nearby” merchants may be populated by acquiring the user's position from the mobile device 30 and comparing it to the locations of the Merchants in the scrollable list 102. The Favorites list may be compiled based on merchants the user has done business with in the past. In other embodiments, other features and aspects may be provided on the Find a Merchant Screen 100. In some embodiments, a search function may be provided to allow the user to search through Merchants by entering search criteria such as a Merchant's name.

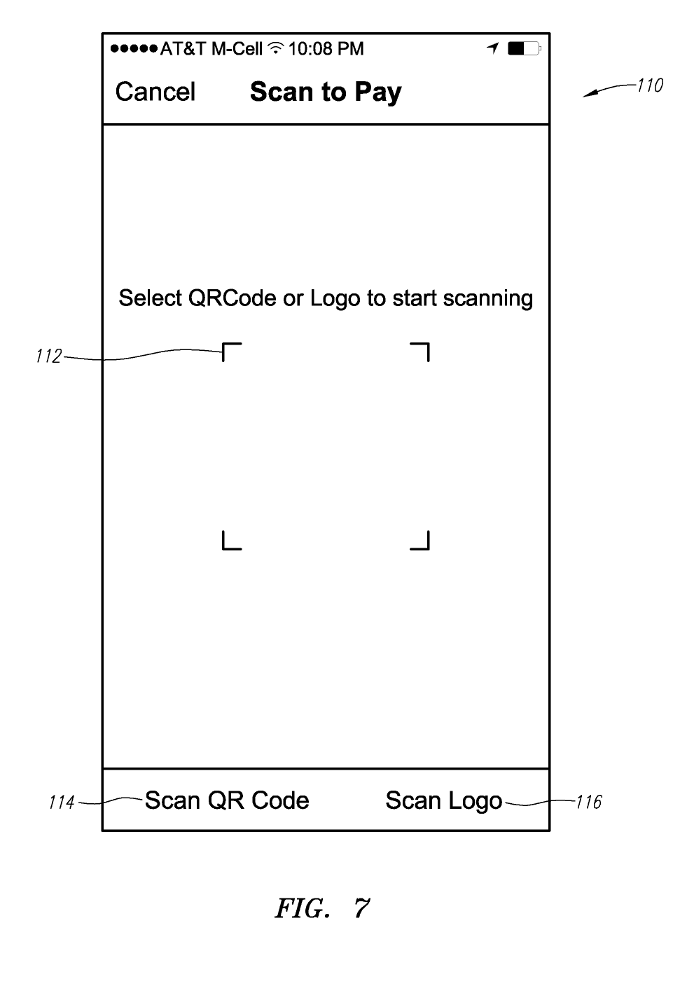

As discussed herein, the methods and apparatus may use a scanned image to initiate a transaction. Returning to FIG. 2, the Home Screen 60 may include a GUI object 67 to initiate a transfer of funds. FIG. 7 illustrates one embodiment of a Scan to Pay Screen 110 for a mobile application according to the embodiments described herein. As may be seen in FIG. 110, the user may be required to select the type of image he/she is scanning In this embodiment the user may select either a QR code 114 or a Logo 116. Once the user selects the type of image they wish to scan, the mobile application accesses the image capture device 34 on the mobile device 30 to capture an image. In a preferred embodiment, brackets 112 may be placed on the screen to help the user center and size the image they are trying to capture. The capture may happen automatically or may require the user to push a button when the user is ready to capture.

Once the image is captured, it may be sent to the network 50 for image analysis. In a preferred embodiment, the network 50 forwards the image to a server where it is analyzed for a match against entries in a database. In preferred embodiments, the mobile application waits for a reply from the network 50 and then instructs the user whether a match was found or not. In some embodiments, the image may be compressed to reduce the size of the image before sending it to the network 50. As part of the compression, the image may be clipped outside the brackets 112. In preferred embodiments compression that does not distort the image past recognition is used.

Many advanced techniques may be used for matching a captured image with images stored in a database. An exact match may not be required and a lower threshold may be set for matching. For example, images that match 80% may be considered a match. In other embodiments, lower thresholds may be set. In some embodiments, as low as 35% of the images may be matched. In situations where multiple database images may match an incoming image within the threshold, the best match may be returned or all the potential matches may be returned and the user may be allowed to select from the potential matches.

In some embodiments, feature based matching may be used to compare scanned images with database images. In other embodiment, are based matching may be used. To this end, the images may be matched in a similar fashion to the way fingerprints are matched.

In a preferred embodiment, the capture device 34, preferably a camera, is run in live mode and a plurality of video frames are grabbed. The frequency of the frame grab may very but preferably it is approximately 10 frames per second. Once the images have been acquired, it may be advantageous to crop the images. Crop the images reduces the image size and thus, the amount of data that needs to be transferred off the phone. In preferred embodiments the capture screen includes a box to help the user align and size the logo they are capturing on the phones camera. The box outline may serve as a good dimensional reference for cropping.

Once the images have been captured and cropped as necessary, they need to be sent from the mobile device to a server for processing. Although in some embodiments, the processing may be done on the mobile device, it is preferably done on a server. In some embodiments, the images may be transmitted to the server using HTTP POST, FTP or any other type of file transport protocol.

Once on the server, the server may extract information about the image such as edges, corners, patterns etc. in order to make a comparison. Numerous types of image analysis software may be used. In some embodiments, Pastec may be used. Pastec is an open source image recognition package designed for use with mobile devices. In other embodiments, other programs may be used.

Once the data is extracted from the images are sent to a server from the mobile device, the extracted data may be compared to similarly extracted data from images contained on the server. The purpose of trying to match the data from the scanned image to images on a server is to eventually establish an owner of the scanned image and thus, a financial account for use in a transaction.

In some embodiments, a dedicated server just for searching for a match for the scanned image may be used. This image server includes a database containing the images for comparison to the scanned image. The images may or may not be related to a financial account. To this end, the database may contain lots of well-known images that do not have a financial account linked to them on a given system. The images may be added to the image server simply for matching and informational purposes.

In some embodiments, a second database or second server may contain entries specifically for all companies that have a financial account on the system. In this way, the image server and image processing may be separate from the financial server and financial processing. In other embodiments, the server with the financial data may also contain image data which is further used for cross-reference against the image server's result. In yet other embodiments, the image analysis and financial transactions may all be handled by the same server.

In operation, the image server may scan its database for any potential matches to the scanned image and then communicate the potential match to the financial server. When searching for a match, images may be scored on the degree of match/relevance. Once a match is found, the match may be cross-reference to an image on the financial server. In other embodiments, no cross reference is use and the results of the first image analysis are used for the financial transaction. Once the owner of the scanned image is established, a financial transaction may proceed using the account of the owner of the scanned image. Accounts may be accounts of merchants, charities or other users.

Although the embodiments described herein have been referring to a mobile application or an application designed to run on a mobile device 30, a similar embodiment may be constructed using a web page formatted for the display of a mobile device 30. In a preferred embodiment, the web page or pages may detect the type and size of the display of the mobile device 30 and format accordingly.

Although the embodiments have been described with reference to preferred configurations and specific examples, it will readily be appreciated by those skilled in the art that many modifications and adaptations of the methods and apparatus for exchanging funds described herein are possible without departure from the spirit and scope of the embodiments as claimed hereinafter. Thus, it is to be clearly understood that this description is made only by way of example and not as a limitation on the scope of the embodiments as claimed below.

What is claimed is:

1. A method of transferring funds comprising:
receiving an image of a logo from a mobile device wherein the image of a logo has been captured by an image capture device integrated into the mobile device;
receiving data from the mobile device the data associated with the image of a logo and identifying a sending party's account;
comparing the image of a logo with a plurality of images of logos stored in a database;
finding a matching image from the plurality of images of logos;
determining a receiving party's account associated with the matching image; and, causing funds to be transferred from the sending party's account to the receiving party's account.

2. The method of claim 1, wherein the image of a logo is a trademark.

3. The method of claim 1, wherein the receiving party's account is associated with a charity.

4. The method of claim 1, further comprising charging a processing fee to the receiving party's account.

5. The method of claim 5, wherein at least a portion of the processing fee is donated to a charity.

6. The method of claim 1, wherein the data includes a transfer amount.

7. The method of claim 1, wherein the sending party's account is a mobile wallet attached to a plurality of funding sources.

8. A method of transferring funds comprising:
installing an entry in a database that includes an image and a receiving party's account associated with the image;
receiving an image from a mobile device, wherein the image has been captured by an image capture device integrated into the mobile device;
receiving data from a mobile device the data associated with the image and identifying a sending party's account;
comparing the image with a plurality of images stored in the database;
finding a matching image from the plurality of images;
determining a receiving party's account associated with the matching image; and,
causing funds to be transferred from the sending party's account to the receiving party's account.

9. The method of claim 8, wherein the image is a logo.

10. The method of claim 8, wherein the image is a trademark.

11. The method of claim 8, wherein the financial account is associated with a charity.

12. The method of claim 8, further comprising charging a processing fee to the receiving party's account.

13. The method of claim 12, wherein at least a portion of the processing fee is donated to a charity.

14. The method of claim 8, wherein the data includes a transfer amount.

15. The method of claim 8, wherein the sending party's account is a mobile wallet attached to a plurality of funding sources.

16. The method of claim 14, where in the transfer amount is a donation to a charity.

17. The method of claim 14, wherein the transfer amount is the cost of goods or services.
